(19) United States
(12) Patent Application Publication
(10) Pub. No.: US 2004/0249023 A1
(43) Pub. Date: Dec. 9, 2004

(54) Compounds for corrosion resistant primer coatings and protection of metal substrates

(76) Inventors: James O. Stoffer, Rolla, MO (US); Pu Yu, Rolla, MO (US); Eric L. Morris, Irvine, CA (US); Thomas J. O'Keefe, Rolla, MO (US); Scott A. Hayes, Rolla, MO (US)

Correspondence Address: LATHROP & GAGE LC, 2345 GRAND AVENUE, SUITE 2800, KANSAS CITY, MO, 64108, US

(21) Appl. No.: 10/346,374

(22) Filed: Jan. 17, 2003

(51) Int. Cl. C08L 5/16; C 08L 1 1/00

(52) U.S. Cl. 524/48; 524/401

(57) ABSTRACT

Primer coating compositions containing rare earth compounds having good adhesion to metals, including aluminum and aluminum alloys, are provided herewith. Also disclosed are processes for preparing said coating compositions, methods of using same, as well as substrates coated with the coating compositions.

### GOVERNMENT INTERESTS

This invention was made with Government support under grant number AFOSRF49620-96-0140 and F33615-97-D5009 awarded by the United States Air Force. The Government may have certain rights in the invention.

### FIELD OF THE INVENTION

This invention is in the field of coatings formed on metal substrates, for example, on aluminum and aluminum alloy substrates. For aerospace and aircraft applications the invention produces coatings exhibiting excellent corrosion resistance performance while maintaining acceptable levels of paint adhesion properties.

### BACKGROUND OF THE INVENTION

Coatings are complex mixtures of chemical substances that can generally be grouped into four broad categories: (1) binders, (2) volatile components, (3) pigments, and (4) additives. Many coatings have several substances from each of the four categories, with the number of combinations being limitless.

Coatings may be employed for a number of reasons. Product coatings or industrial coatings are typically applied in a factory on a given substrate or product, such as appliances, automobiles, aircraft, and the like. Many industries, including the aircraft industry, typically employ coating systems that provide both protection and enhanced performance.

U.S. Pat. No. 6,312,812, issued Nov. 6, 2001, provides a composition for coating a metal substrate which contains a Group IIIB, Group IVB, or lanthanide series element, an epoxy resin, and at least one material containing an amine, sulfur, or phosphorous. Examples of the Group IIIB, Group IVB, or lanthanide series compounds include nitrates, acetates, sulfamates, lactates, glycolates, formates, and dimethylol propionates.

U.S. Pat. No. 6,217,674, issued Apr. 17, 2001, provides a composition for passivating metal substrates containing a Group IIIB or Group IVB metal or metal compound, an epoxy resin, and a dialkanolamine.

U.S. Pat. No. 4,594,369, issued Jun. 10, 1986, provides corrosion inhibiting particles including molybdate-exchanged alumina particles and inorganic oxides having surface hydroxyl groups, wherein the inorganic oxide is preferably alumina. Other oxides which may be suitable include silica, zirconia, iron oxides, and tin oxides.

Corrosion inhibitors based on ion-exchange have been developed by Cayless⁴, Howes⁷, Pippard⁵, and Fletcher⁶, where an inorganic exchanger, such as alumina or silica oxide, was employed.

Cayless used the inorganic exchanger in conjunction with molybdate ions claiming improved corrosion resistance. Currently, no exchange resins based on organic material incorporating rare earth compounds, including praseodymium compounds, have been reported. Abdel-Aal⁸, Hluchan⁹, Abdel-Rahim¹⁰, and Lukacs¹¹ have investigated the use of amino acids as corrosion inhibitors for steel, primarily as solutions. Amino acids or exchange resins in primer systems containing rare earth compounds for aluminum alloy corrosion resistance have not been utilized

Current corrosion inhibitors for primer systems on aluminum alloys are based on strontium chromate, which provides excellent corrosion resistance when properly incorporated into paint formulations. However, in recent years there has been widespread concern over the use of chromates, as they are known to be highly toxic and carcinogenic. Furthermore, the disposal of chromate materials is becoming increasingly difficult as municipal and government regulations become more stringent. Because of the health risk and impending government legislation associated with the application of hexavalent chromium-containing solutions and their disposal, change in the metal finishing industry is inevitable.

Environmental concern over the use of chromate-containing coatings has thus become increasingly important in the coating industry. This concern not only extends to preservation of the environment for its own sake, but also extends to public safety as to both living and working conditions. The U.S. Environmental Protection Agency (EPA) has established guidelines limiting the amount of chromium-containing compounds released to the environment, such guidelines being scheduled for adoption or having been adopted by various states in the U.S. Hence, the development of non-chromium-containing formulations for use in the coating industry is of value.

Hager et al.¹ reports the use of esters of rare earth metals, such as lanthanum and cerium oxalates and cerium acetates, or a chloride of a rare earth metal either alone or in combination with other said salts. Hinton et al.² and Arnott et al.³ report the use of rare earth salts, namely chloride salts, for the purpose of conversion coating aluminum alloy substrates. However, no use of rare earth oxides or mixed oxides, including praseodymium (III/IV) mixed oxides, praseodymium(III) oxides, or praseodymium(IV) oxides as corrosion inhibitors designed specifically for primer applications have been reported.

Toxicology reports indicate that praseodymium is environmentally safe, with similar environmental behavior aspects as cerium and other rare earth metals. Research has been conducted on the oxidative properties and stabilities of praseodymium compounds, but no significant contribution to primers using the oxides or mixed oxides have been reported.

Thus, it would be a significant contribution to the art to provide primer coating compositions containing rare earth oxides, rare earth mixed oxides, and/or rare earth triflates, alone or in combination with other components, processes for the preparation of same, as well as methods of using these coating compositions, all having good adhesion to metal substrates, including aluminum and aluminum alloys, bare and galvanized steel, zinc, magnesium and magnesium alloys, and the metal substrates coated therewith.

### SUMMARY OF THE INVENTION

The present invention relates to aqueous or solvent borne coating compositions containing rare earth oxides, rare earth mixed oxides, and/or rare earth triflates, alone or in combination with other components, having corrosion resistant properties with good adhesion to metals, including aluminum and aluminum alloys, bare and galvanized steel, zinc, magnesium and magnesium alloys.

The invention further relates to processes for preparing said coating compositions containing rare earth oxides, rare earth mixed oxides, and/or rare earth triflates, alone or in combination with other components, having corrosion resistant properties with good adhesion to metals, including aluminum and aluminum alloys, bare and galvanized steel, zinc, magnesium and magnesium alloys.

The present invention additionally relates to aqueous or solvent borne coating compositions containing metal sulfates, wherein said metal is selected from the group consisting of calcium, strontium, and barium, alone or in combination with other components, having corrosion resistant properties with good adhesion to metals, including aluminum and aluminum alloys, bare and galvanized steel, zinc, magnesium and magnesium alloys.

The invention further relates to processes for preparing said coating compositions containing metal sulfates, wherein said metal is selected from the group consisting of calcium, strontium, and barium, alone or in combination with other components, having corrosion resistant properties with good adhesion to metals, including aluminum and aluminum alloys, bare and galvanized steel, zinc, magnesium and magnesium alloys.

The invention additionally relates to methods of using said coating compositions.

The invention still further relates to metal substrates, including aluminum and aluminum alloys, bare and galvanized steel, zinc, magnesium and magnesium alloys, coated therewith.

### DETAILED DESCRIPTION OF THE INVENTION

The invention provides compositions for primer coatings that allow for improved corrosion resistance of metal substrates. Moderate to low concentrations of rare earth compounds, such as rare earth oxides and mixed oxides, triflates, and/or carbonates alone or in combination with other materials or components, have been formulated into coating mixtures providing corrosion resistance. Additionally provided are metal sulfates, wherein said metal is selected from the group consisting of calcium, strontium, and barium, alone or in combination with other materials or components, that have been formulated into coating mixtures providing corrosion resistance.

These other components may include amino acids, including glycine, arginine, methionine, and derivatives of amino acids, such as methionine sulfoxide, methyl sulfoxide, and iodides/iodates, gelatin and gelatin derivatives, such as animal and fish gelatins, linear and cyclic dextrins, including alpha and beta cyclodextrin, triflic acid, triflates, acetates, talc, kaolin, organic-based ionic exchange resins, such as organic-based cationic and anionic exchange resins, organic-based ionic exchange resins, such as organic-based cationic and anionic exchange resins, organic-based ionic exchange resins that have been pre-exchanged or reacted with the salts, oxides, and/or mixed oxides of rare earth material, and metal sulfates, such as sulfates of rare earth materials, magnesium sulfate, calcium sulfate (anhydrous and hydrated forms), strontium sulfate, barium sulfate, and the like. These materials may be referred to as other components. Any of these materials referenced above alone or in combination are contemplated by the present invention.

The rare earth compounds may be based on any of the lanthanide series. Preferred for the practice of the invention are praseodymium, cerium, and terbium. Particularly preferred are praseodymium and terbium, with the most currently preferred being praseodymium. The oxidation state of the rare earth metal employed is important. For example, in the case of praseodymium, generally the preferred oxidation state is praseodymium(III), followed by a praseodymium(III/IV) mixture, and then by praseodymium(IV). The preferred oxidation states of the rare earth compounds may also be a function of the final coating system employed.

The rare earth compounds alone or in combination with the other materials have been incorporated into commercially available primer formulations as corrosion inhibitors. Evaluation of these primer coatings containing the rare earth compounds alone or in combination with the other materials in neutral salt fog environments demonstrates that the presence of these corrosion inhibitors improves the overall corrosion resistance of the metal substrate. Elemental characterization of these systems suggests leaching of the inhibitor passivates and protects the underlying metal substrate.

The metal sulfates, wherein said metal is selected from the group consisting of calcium, strontium, and barium, have also been incorporated into commercially available primer formulations as corrosion inhibitors. Evaluation of these primer coatings containing the metal sulfate compounds alone or in combination with the other materials in neutral salt fog environments also demonstrates that the presence of these corrosion inhibitors improves the overall corrosion resistance of the metal substrate.

The corrosion inhibitors described above are combined with at least one type of organic polymer, wherein the organic polymers include those soluble in water and those soluble in non-aqueous systems and powder coating systems. Polymers that are film-forming and that crosslink upon curing are preferred. Examples of these polymers include epoxy, urethane, urea, acrylate, alkyd, melamine, polyester, vinyl, vinyl ester, silicone, siloxane, silicate, sulfide, sulfone, epoxy novolac, epoxy phenolic, amides, drying oils, and hydrocarbon polymers.

The corrosion inhibitors are preferably prepared in a liquid form. Thus, the organic polymer is dispersed or dissolved in an appropriate solvent, such as water or a non-aqueous solvent depending on the nature of the polymer, and the appropriate amount of corrosion inhibitor is added.

The corrosion inhibitors described above were evaluated in a polyamide/epoxy-based water reducible primer paint formulation, but the system is not limited to this specific epoxy-based system, and the corrosion inhibitors may be incorporated into other primer paint formulations and employed in other applications where corrosion prevention is desired. Other resins may include e-coats, epoxy, urethane, urea, acrylate, alkyd, melamine, polyester, vinyl, vinyl ester, silicone, siloxane, silicate, sulfide, sulfone, epoxy novilac, epoxy phenolic, amides, drying oils, and hydrocarbon polymers. The preferred polymer system is a water reducible epoxy-polyamide system.

The polyamide/epoxy-based water reducible primer paint formulation used herein was obtained from Deft Inc., Irvine, Calif., and is identified as the Deft 44GN72 system containing no strontium chromate.

Addition of 0.1-20.0 wt %, and preferably 0.4-8 wt %, of a rare earth compound into a primer formulation (or a paint ready to apply) may be by any conventional method known in the art. The primer may also include 0.1-5.0 wt % and preferably 0.5-3.0 wt % of an organic-based ionic exchange resin. The resin may be either cationic or anionic in nature, both cationic and anionic may be used in the same primer formulation, and the ionic exchange resin may contain rare earth compounds and/or amino acids as pre-exchanged species prior to incorporation into a primer formulation. The primer may contain 0.03-5.0 wt %, and preferably 0.1-1.2 wt %, complexing sugars and/or gelatin. The primer may also contain 0.1-5.0 wt %, and preferably 0.5-1.5 wt %, amino acids.

Co-inhibitors known in the art may also optionally be employed in the present formulation, such as metal oxides, borates, metaborates, silicates, phosphates, phosphonates, aniline, polyaniline, and the like. Other co-inhibitors may also be optionally employed in the present invention, such as Nalzan, Busan, Halox, Molywhite, and the like. Co-inhibitors may be employed so long as they are chosen in such a way as to be chemically compatible with the corrosion inhibitor primer composition.

Controlling the local environment near the primer and substrate interface is also important for maximum corrosion protection provided by these corrosion inhibitors. Local pH and ionic activity may be modified in a favorable way using either extender pigments with an inherent pH characteristic or by ionic exchange resins, or both. The pH of the polymer resins used may also influence the local pH. Incorporation of rare earth compounds in conjunction with appropriate extenders, combinations with any of the above, and/or amino acids can further improve the corrosion resistance of these primer systems.

Extender pigments, or other filler materials, are often used extensively in paint coating applications. These extenders may serve several purposes, such as a cost effective substitute for coloring pigments like TiO₂, as well as providing the desired pigment to binder ratios for the primer coatings. The extenders currently used in primer and paint coatings are often basic in nature. To assist in the transport of inhibitor species from the primer coating to areas of exposed underlying metal substrate, extenders which have more neutral to slightly acidic pHs were used. Though the corrosion inhibitors mentioned above do provide corrosion protection in corrosive salt spray environments, extenders with a more neutral to slightly acidic nature are preferred, such as calcium sulfate dihydrate, or gypsum. It is believed that the neutral to acidic nature of these extenders helps to create an environment in the primer and near the metal substrate which helps to enhance and optimize transport of the inhibitor species.

The anions of metal cations with varied solubility, such as calcium sulfate, calcium sulfate dihydrate, strontium sulfate, magnesium sulfate, and the like, have been identified to enhance the corrosion resistance of the protective primer coating. The transport of the corrosion inhibitors incorporated into the organic polymer-containing water reducible primer, individually or in combination, is further enhanced when soluble metal sulfates, such as calcium sulfate dihydrate, are incorporated as extenders into the primer paint formulation. Extenders are preferred for the practice of the present invention. Particularly preferred extenders include CaSO₄.2H₂O, SrSO₄, and MgSO₄.7H₂O.

System enhancers may be employed to enhance and optimize transport of the functional species in the coating and ultimately increase the concentration of the active inhibitor at the corrosion sites. Parameters that affect this may include conversion coatings, grind/primer pigment fineness, extenders, dust coat, and combinations of same.

Conversion coatings may include cerium conversion coatings (CeCC), praseodymium conversion coatings (PrCC), phosphate conversion coatings, zinc-type conversion coatings, and chromium conversion coatings (CrCC). The conversion coatings evaluated in conjunction with the present invention include CrCC, such as those obtained using the Alodine (from Henkel) and Iridite (from McDermid) processes, chromic acid anodized with chrome seal, sulfuric acid anodized with chrome seal, and the like. The age and thickness of the applied conversion coatings may further influence the corrosion resistance of the subsequent paint coatings. It is preferred to apply the paint coating over a conversion coating which is less than three days old and is relatively moderate to heavy in thickness, but yet still provides excellent adhesion to the underlying substrate. Conversion coatings that are too thick tend to result in primers with cohesive failure in the conversion coating layer. The proper conversion coating thickness will be readily apparent to one of ordinary skill in the art.

Additional additives and pigments may be employed to provide desired aesthetic or functional effects. If desired, the coating composition may contain other optional materials well known in the art of formulated surface coatings. These optional materials would be chosen as a function of the coating system and application and may include flow control agents, thixotropic agents such as bentonite clay, fillers, anti-gassing agents, organic co-solvents, catalysts, and other customary auxiliaries. These materials, if used, can constitute up to 40 percent by weight of the total weight of the coating composition.

The coating composition of the present invention may optionally contain pigments to give it color. In general, the pigment is incorporated into the coating composition in amounts of about 1 to 80 percent, usually about 1 to 30 percent by weight based on total weight of the coating composition. Color pigments conventionally used in surface coatings include inorganic pigments such as titanium dioxide, iron oxide, carbon black; phthalocyanine blue, and phthalocyanine green. Metallic flake pigmentation is also useful in aqueous coating compositions of the present invention. Suitable metallic pigments include aluminum flake, copper bronze flake, and metal oxide coated mica. The optional pigments may comprise up to approximately 25 weight percent of the coating composition.

The preferred concentration ranges of the components in the coating, as well as the PVC (pigment volume concentration) of the coating, may vary based on the resin/primer system employed. In concentration ranges provided, the weight percentages are based on a fully catalyzed and water reduced sprayable paint.

Preferred for the practice of the present invention is a fully catalyzed and water reduced sprayable paint composition which comprises 0.1-40 wt % Pr₆O₁₁. Particularly preferred is 0.1-28 wt % Pr₆O₁₁. Most particularly preferred is 0.1-11.0 wt % Pr₆O₁₁. Preferred for the practice of the present invention is a coating which comprises a PVC in the range of 0.1-65 wt % PVC. Particularly preferred is 10-55 wt % PVC. Most preferred is a 25-45 wt % PVC. Other preferred ranges are as follows:

| | | |
|---|---|---|
| Pr₆O₁₁: | Range: 0.1-40% | Preferred - 0.4-8.0 wt % |
| Pr₂O₃: | Range: 0.1-40% | Preferred - 0.4-8.0 wt % |
| PrO₂: | Range: 0.1-40% | Preferred - 0.4-8.0 wt % |
| PrO₂ + Pr₂O₃: | Range: 0.1-40% | Preferred - 0.4-8.0 wt % |
| Tb₄O₇: | Range: 0.1-40% | Preferred - 0.4-8.0 wt % |
| CeO₂ Hydrous | Range: 0.1-40% | Preferred - 0.4-8.0 wt % |
| Pr(OH)₃: | Range: 0.1-40% | Preferred - 0.4-8.0 wt % |
| Sm₂O₃: | Range: 0.1-40% | Preferred - 0.4-8.0 wt % |
| Yb₂O₃: | Range: 0.1-40% | Preferred - 0.4-8.0 wt % |
| Y₂O₃: | Range: 0.1-40% | Preferred - 0.4-8.0 wt % |
| La₂O₃: | Range: 0.1-40% | Preferred - 0.4-8.0 wt % |
| Nd₂O₃: | Range: 0.1-40% | Preferred - 0.4-8.0 wt % |

For the additional materials, the following wt % ranges are preferred:

| | | |
|---|---|---|
| CaSO₄.2H₂O: | Range: 6.0-35% | Preferred - 16.1-18.8 wt % |
| SrSO₄: | Range: 6.0-35% | Preferred - 16.1-18.8 wt % |
| Ca(H₂PO₄)₂.H₂O: | Range: 6.0-35% | Preferred - 16.1-18.8 wt % |
| CaSO₄.Anhyd.: | Range: 6.0-35% | Preferred - 16.1-18.8 wt % |
| BaSO₄.2H₂O: | Range: 6.0-35% | Preferred - 16.1-18.8 wt % |
| CaCO₃.2H₂O: | Range: 6.0-35% | Preferred - 16.1-18.8 wt % |
| Kaolin: | Range: 6.0-35% | Preferred - 16.1-18.8 wt % |
| Sr Carbonate: | Range: 6.0-35% | Preferred - 16.1-18.8 wt % |
| Pr Carbonate: | Range: 6.0-35% | Preferred - 16.1-18.8 wt % |
| La₂SO₄: | Range: 6.0-35% | Preferred - 16.1-18.8 wt % |
| Li₂SO₄ | Range: 6.0-35% | Preferred - 16.1-18.8 wt % |
| L Arginine: | Range: 0.1-5.0 wt % | Preferred - 0.5-1.5 wt % |
| D,L Arginine: | Range: 0.1-5.0 wt % | Preferred - 0.5-1.5 wt % |
| D Methionine: | Range: 0.1-5.0 wt % | Preferred - 0.5-1.5 wt % |
| L Methionine: | Range: 0.1-5.0 wt % | Preferred - 0.5-1.5 wt % |
| D,L Methionine: | Range: 0.1-5.0 wt % | Preferred - 0.5-1.5 wt % |
| Glycine: | Range: 0.1-5.0 wt % | Preferred - 0.5-1.5 wt % |
| L-Cystiene: | Range: 0.1-5.0 wt % | Preferred - 0.5-1.5 wt % |
| Cystene: | Range: 0.1-5.0 wt % | Preferred - 0.5-1.5 wt % |
| Proline: | Range: 0.1-5.0 wt % | Preferred - 0.5-1.5 wt % |
| Ethylenediaminetetraacetic acid (Free): | Range: 0.1-5.0 wt % | Preferred - 0.5-1.5 wt % |
| Ethylenediaminetetraacetic acid | Range: 0.1-5.0 wt % | Preferred - 0.5-1.5 wt % |
| (Disodium salt): | | |
| D,L Methionine Sulfoxide: | Range: 0.1-5.0 wt % | Preferred - 0.5-1.5 wt % |
| L-Methionine methylsulfonium iodide: | | |
| Animal Gelatin: | Range: 0.03-5.0 wt % | Preferred - 0.1-1.2 wt % |
| Proline of Fish Gelatin: | Range: 0.03-5.0 wt % | Preferred - 0.1-1.2 wt % |
| Alpha or Beta Cyclodextrins: | Range: 0.03-5.0 wt % | Preferred - 0.1-1.2 wt % |
| Sulfonated Cyclodextrins: | Range: 0.03-5.0 wt % | Preferred - 0.1-1.2 wt % |
| Triflic Acid: | Range: 0.1-0.5 wt % | Preferred - 0.3 wt % |
| Pr Triflate: | Range: 0.4-5 wt % | Preferred - 0.7-3.0 wt % |
| Ce Triflate: | Range: 0.4-5 wt % | Preferred - 0.7-3.0 wt % |
| Reilex (As is): | Range: 0.1-5.0 wt % | Preferred - 0.5-3.0 wt % |
| Whatman CM23 (As is): | Range: 0.1-5.0 wt % | Preferred - 0.5-3.0 wt % |
| Whatman CM23 Pre-Exchanged | Range: 0.1-5.0 wt % | Preferred - 0.5-3.0 wt % |
| with Praseodymium Triflate: | | |
| Whatman CM23 Pre-Exchanged | Range: 0.1-5.0 wt % | Preferred - 0.5-3.0 wt % |
| with Methionine | | |
| Whatman DE23 (As is): | Range: 0.1-5.0 wt % | Preferred - 0.5-3.0 wt % |
| Whatman P11 (As is): | Range: 0.1-5.0 wt % | Preferred - 0.5-3.0 wt % |
| Whatman CM23 Pre-Exchanged with | Range: 0.1-5.0 wt % | Preferred - 0.5-3.0 wt % |
| Praseodymium Salt such as a Nitrate Salt: | | |
| Whatman CM23 Pre-Exchanged with | Range: 0.1-5.0 wt % | Preferred - 0.5-3.0 wt % |
| Cerium Salt such as a Nitrate Salt: | | |
| Whatman CM23 Pre-Exchanged | Range: 0.1-5.0 wt % | Preferred - 0.5-3.0 wt % |
| with Sulfuric Acid: | | |
| Pr Carbonate: | Range: 0.5-5.0 wt % | Preferred - 2.0-3.0 wt % |
| MgSO₄.7H₂O | Range: 1.0-3.0 wt % | Preferred - 1.5-2.5 wt % |
| Pr Sulfate: | Range: 0.1-5.0 wt % | Preferred - 0.5-2.5 wt % |
| Sm Acetate: | Range: 0.1-5.0 wt % | Preferred - 0.5-2.5 wt % |

There are many ways to manufacture a paint or coating. Any conventional method for manufacturing a paint or coating can be used. Examples of such include the use of drill presses powered by compressed air or electricity, sand mills which use appropriate grinding media, and the like. The following is an example of how a primer containing any individual or combination of the above inhibitors may be produced.

The mill base for a polyamide/epoxy-based water reducible primer formulation was prepared by first dispersing the resin, additives/surfactants, and solvents blend in an appropriately sized container at 650 rpm using a standard Cowell's dispersion blade and a standard drill press. Under agitation at 650 rpm, the coloring pigments, such as TiO₂, mineral or extender/filler material, such as kaolin and Mistron 604, and the corrosion inhibitors or any combination of corrosion inhibitors mentioned above are incorporated into the polyamide/epoxy-based water reducible primer formulation. If an appropriate grinding media is desired, it is to be added at this time. Once all of the material is properly added to the formulation, this mill base is allowed to disperse for about five more minutes at 650 rpm, after which the dispersion speed is increased to 1620 rpm until the desired mill base pigment grind is obtained. During dispersion at 1620 rpm, the temperature of the mill base is monitored and is kept below the recommended temperatures for the ingredients and resin systems used. If it appears that the mill base temperature is close to exceeding the recommended temperatures for the stability of the ingredients or resins, the dispersion speed maybe reduced appropriately or the dispersion process may be halted momentarily to allow proper cooling. Other steps, such as using cooling systems to minimize higher dispersion temperatures have also been used.

Once the desired pigment particle size for the mill base grind is obtained, the dispersion process is halted, and the primer mill base is then filtered, if desired, to remove any undesired material from the paint, such as grinding media that may have optionally been used.

An optional step is to allow the mill base to set for at least twenty-four hours prior to use. One reason is to allow the resin to properly wet all of the pigments. The shelf life of the primer prior to use is dictated by the time specifications provided by the supplier of the resin system.

The polyamide/epoxy water reducible primer is then prepared by adequately stirring appropriate amounts of the epoxy catalyst to the mill base described above. One example of an epoxy catalyst for polyamide/epoxy water reducible primer formulations is an epoxy/nitroethane solution available from Deft, manufacturer's code number 44WO16CAT.

The amount of epoxy catalyst to mill base depends on the amount recommended by the supplier of this coating system to ensure proper curing and cross-linking of the resulting primer paint film. Once the appropriate amounts of epoxy catalyst and mill base are well mixed together, the appropriate amount of water is then slowly mixed into the primer mill base/epoxy catalyst blend. The purity and amount of the water added depends on what is recommended by the supplier of the coating system based on the spray viscosity and final use of the coating. Since the paint formulation is a water reducible system, care needs to be taken when adding the aqueous component to the epoxy catalyst/mill base blend, similar to the care that is already taken when using these Deft 44GN72-type systems.

The medium employed in the preparation of the coating system of the present invention is chosen in such a manner as to facilitate the preparation of the coating mixture, and to provide suitable adhesion to the substrate. The preferred medium is water, which would include the preparation of water borne coatings. Other systems would include solvent-based and powder coatings.

Once the mill base/epoxy blend and appropriate amount of water have been mixed together, the primer is now ready for application to the substrate. Suitable metal substrates include aluminum, aluminum alloys, cast aluminum, magnesium, magnesium alloys, titanium, zinc, galvanized zinc, zinc-coated steel, zinc alloys, zinc-iron alloys, zinc-aluminum alloys, steel, stainless steel, pickled steel, iron compounds, magnesium alloys, and the like. Preferred substrates for the practice of the present invention are aluminum and aluminum alloys.

The metal surface to be coated may be that of a fabricated article. Suitable fabricated articles to be coated with the aqueous coating composition of the present invention include aircraft components and parts.

The coating mixtures of the invention may be applied to the surfaces of a metal substrate using any conventional technique, such as spraying, painting with a brush, painting with rollers, dipping, and the like, but they are most often applied by spraying. The usual spray techniques and equipment for air spraying and electrostatic spraying and either manual or automatic methods can be used. Preferred for the practice of the present invention is spray coating.

It is preferred that the metal surface be prepared to receive the coating. This preparation includes the conventional method of first cleaning the surface to remove grease and other contaminants. Once the surface is free of surface contaminants, it may be treated to remove any oxide coating, and in certain instances to provide a conversion coating to which the corrosion-inhibiting mixture may more readily bond. In the event that the surface has a thick oxide coating, then this coating may be removed by conventional means, such as immersion in a series of sequential chemical baths containing concentrated acids and alkalis that remove such a surface coating.

The surface to be coated is optionally and preferably treated to provide a conversion coating, for example by immersion in concentrated chromic acid. When an aluminum substrate is used, for example, this process produces a controlled mixture of aluminum oxides on the surface of an aluminum or aluminum alloy substrate. Alternatively, the surface may be treated with a boric acid/sulfuric acid anodizing process. This process produces a controlled mixture of aluminum oxides in the surface of an aluminum or aluminum alloy substrate. Preferred for the practice of the invention are chromium-based conversion coatings.

Optionally, after the surface has been treated to provide a conversion coating, the surface may be sealed by dipping the substrate into a dilute solution of chromic acid. The clean surface, whether sealed or unsealed, may then be coated with the coating mixtures of the invention.

The coating formed on the substrate during application will be from about 1 to about 3 mils, and preferably 0.8 to 1.2 mils in thickness for said water reducible polyamide epoxy systems, but ultimately the thickness may vary based on application requirements.

Typically, after application of the coating, the coating on the coated substrate is then cured using a suitable means. Typical curing methods include air drying, and/or heating. The method of curing will depend on the type of coating mixture employed. Preferred for the practice of the present invention is the use of air drying, for a period of about 2 weeks.

Other uses for these corrosion inhibitor coating compositions include other paint systems, for example, topcoat and possible one-coat systems, and self-priming paints.

Once the primer is applied, it may either receive subsequent topcoats, or may be cured as a stand alone coating. If the primer is to receive a subsequent topcoat, or several subsequent coatings, then the subsequent coating should be applied so as to be compatible with the coating layer already present, typically in accordance with the resin and/or topcoat manufacturers' specifications. If the primer coating does not receive any subsequent topcoats, the primer may then be allowed to cure.

### EXAMPLES

### Example 1

### Primer Mill Base Formulation

Oxides, either anhydrous or hydrated, and hydroxides of rare earth elements have been evaluated as being non-toxic alternatives to chromates. Rare earth oxides, either anhydrous or hydrated, and hydroxides, such as Cerium (IV) Oxide, Cerium (IV) Oxide dihydrate, Praseodymium (III) Oxide, and the like, have been incorporated into polyamide/epoxy water reducible primer formulations. One example of a polyamide/epoxy water reducible primer mill base formulation containing rare earth salts is as follows:

| | |
|---|---|
| Polyamide Resin Blend | 341 g |
| Additive | 5 g |
| 2-Butanol Solvent | 71 g |
| TiO₂(R-960) | 143 g |
| Rare Earth Oxide(s) | 40 g |
| Extender/Filler Pigment | 400 g |
| Mill Base Total: | 1000 g |

The concentration of the corrosion inhibitors used as individuals range from 0.4 wt % (Pr₂O₃ panel Al51) to 12.0 wt % (CeO₂.H₂O Panel). Where the wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst/activator would consist of a solvent, an additive, and a resin blend, such as Deft's epoxy/nitroethane solution, manufacturer's code number 44WO16CAT.

Once the appropriate amounts of epoxy catalyst and mill base are well mixed together, the appropriate amount of water was then slowly mixed into the primer mill base/epoxy catalyst blend. The purity and amount of the water added depends on what is recommended by the supplier of the coating system based as described above. Procedures for mixing of the primer, shelf life of primer mill base, spray life of catalyzed and water reduced primer, and the like, are in accordance with the specifications of the supplier of the resin material. Examples of such primer formulations that have been prepared and evaluated are provided in Tables 1 and 2.

Mixed oxides, either anhydrous or hydrated, and hydroxides of mixed oxides of rare earth elements have been evaluated as being non-toxic alternatives to chromates. Rare earth mixed oxides, either anhydrous or hydrated, and hydroxides, such as Terbium (III/IV) Oxide, Praseodymium (III/IV) Oxide, and the like, have been incorporated, individually and in combination, into polyamide/epoxy water reducible primer formulations. One example of a polyamide/epoxy water reducible primer mill base formulation containing rare earth salts is as follows:

### Example 2

Primer Mill Base Formulation

| | |
|---|---|
| Polyamide Resin Blend | 328 g |
| Dispersing Agent | 5 g |
| 2-Butanol Solvent | 68 g |
| Ti0₂ | 137 g |
| Rare Earth Mixed Oxide(s) | 77 g |
| (Anhy./Hydrous./Hydroxide) | |
| Extender/Filler Pigment | 385 a |
| Mill Base Total: | 1000 g |

The concentration of the corrosion inhibitors used as individuals range from 1.0 wt % (Pr₆O₁₁, panel A22) to 22.2 wt % (Pr₆O₁₁ panel 227). Where the wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst/activator would consist of a solvent, an additive, and a resin blend, such as Deft epoxy/nitroethane solution, manufacturer's code number 44WO16CAT.

Examples of such primer formulations that have been prepared and evaluated are provided in Tables 1 and 2 below.

Amine-based aliphatic, aromatic, cyclic, and or sulfur containing compounds have been evaluated as being non-toxic alternatives to chromates. Amine-based aliphatic, aromatic, cyclic, and or sulfur containing compounds, for example amino acids, such as L-arginine, D,L-arginine, D-methionine, L-methionine, D,L-methionine, glycine, proline, L-cysteine, etc., and other amine-based compounds, such as ethylenediaminetetra-acetic acid (EDTA), di-sodium salts of EDTA, and the like, have been incorporated into polyamide/epoxy water reducible primer formulations. One example of a polyamide/epoxy water reducible primer mill base formulation containing these types of compounds is as follows:

### Example 3

Primer Mill Base Formulation

| | |
|---|---|
| Polyamide Resin Blend | 351 g |
| Dispersing Agent | 5 g |
| 2-Butanol Solvent | 73 g |
| TiO₂ | 146 g |
| Amine-based aliphatic, aromatic, cyclic, | 14 g |
| and/or sulfur containing compound(s) | |
| Extender/Filler Pigment | 411 g |
| Mill Base Total: | 1000 g |

The concentration of the amino acids used range from 0.50 wt % (D,L-Methionine panel 0214) to 1.5 wt % (D,L-Methionine panel 232). The wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst/activator would consist of a solvent, an additive, and a resin blend, such as Deft's epoxy/nitroethane solution, manufacturer's code number 44WO16CAT.

Examples of such primer formulations that have been prepared and evaluated are provided in Tables 1 and 2 below.

Derivatives of amine-based aliphatic, aromatic, cyclic, and or sulfur containing compounds have been evaluated and verified as being non-toxic alternatives to chromates. Derivatives of amine-based aliphatic, aromatic, cyclic, and or sulfur containing compounds, such as D,L-methionine sulfoxide, L-methionine methylsulfonium iodide, and the like, have been incorporated into polyamide/epoxy water reducible primer formulations. One example of this composition, concentrations, material ratios, vendor materials, or vendor supplier, of a polyamide/epoxy water reducible primer mill base formulation containing these types of compounds is as follows:

### Example 4

Primer Mill Base Formulation

| | |
|---|---|
| Polyamide Resin Blend | 351 g |
| Dispersing Agent | 5 g |
| 2-Butanol Solvent | 73 g |
| TiO₂ | 146 g |
| Derivative(s) of amine-based aliphatic, aromatic, | 14 g |
| cyclic, and/or sulfur and/or iodide | |
| containing compound(s) | |
| Extender/Filler Pigment | 411 g |
| Mill Base Total: | 1000 g |

The concentration of the corrosion inhibitors used as individuals range from 0.51 wt % (D,L-methionine sulfoxide panel 0179) to 1.05 wt % (D,L-Methionine Sulfoxide panel 234). Where the wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst/activator would consist of a solvent, an additive, and a resin blend, such as Deft's epoxy/nitroethane solution, manufacturer's code number 44WO16CAT.

Examples of such primer formulations that have been prepared and evaluated are provided in Tables 1 and 2 below.

Gelatin and gelatin derivatives have been evaluated as being non-toxic alternatives to chromates. Gelatin and gelatin derivatives, such as but not limited to animal gelatins and derivatives, fish gelatins and derivatives, and the like, have been incorporated into polyamide/epoxy water reducible primer formulations. One example of a composition, concentrations, material ratios, vender materials, or vender supplier, of a polyamide/epoxy water reducible primer mill base formulation containing these types of compounds is as follows:

### Example 5

Primer Mill Base Formulation

| | |
|---|---|
| Polyamide Resin Blend | 351 g |
| Dispersing Agent | 5 g |
| 2-Butanol Solvent | 73 g |
| TiO₂ | 146 g |
| Gelatin(s) and or | 14 g |
| Gelatin Derivative(s) | |
| Extender/Filler Pigment | 411 g |
| Mill Base Total: | 1000 g |

The concentration of the corrosion inhibitors used as individuals range from 0.03 wt % (Animal Gelatin+Pr₆O₁₁+Ce(NO₃)₃ panel A66E) to 1.0 wt % (Animal Gelatin+Pr₆O₁₁+Ce(NO₃)₃ panel A28). Where the wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst/activator would consist of a solvent, an additive, and a resin blend, such as Deft's epoxy/nitroethane solution, manufacturer's code number 44WO16CAT.

Examples of such primer formulations that have been prepared and evaluated are provided in Tables 1 and 2 below.

Chirally Active Dextrins have been evaluated as being non-toxic alternatives to chromates. Chirally Active Dextrins, such as alpha cyclodextrin, beta cyclodextrin, sulfonated cyclodextrins, and the like, have been incorporated into polyamide/epoxy water reducible primer formulations. One example of a polyamide/epoxy water reducible primer mill base formulation containing these types of compounds is as follows:

### Example 6

Primer Mill Base Formulation

| | |
|---|---|
| Polyamide Resin Blend | 351 g |
| Dispersing Agent | 5 g |
| 2-Butanol Solvent | 73 g |
| TiO₂ | 146 g |
| Chirally Active Dextrin(s) | 14 g |
| Extender/Filler Pigment | 411 g |
| Mill Base Total: | 1000 g |

The concentration of the corrosion inhibitors used was primarily at 1.5 wt %

(Cyclodextrin+Ce(NO3)3+Pr6O11 panel C41. The wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst/activator would consist of a solvent, an additive, and a resin blend, such as Deft's epoxy/nitroethane solution, manufacturer's code number 44WO16CAT.

Examples of such primer formulations that have been prepared and evaluated are provided in Tables 1 and 2 below.

Organic-based ionic exchange resins have been evaluated as being non-toxic alternatives to chromates. Organic-based ionic exchange resins; such as organic-based cationic resins, for example Whatman fibrous cellulose phosphate cation exchanger P11, Whatman fibrous carboxymethyl cellulose cation exchanger CM23, and the like, and anionic exchange resins, for example Whatman fibrous diethylaminoethyl cellulose anion exchanger DE23, and Reilex 402 Polymer, and the like, have been incorporated into polyamide/epoxy water reducible primer formulations. One example of a polyamide/epoxy water reducible primer mill base formulation containing rare earth salts is as follows:

### Example 7

Primer Mill Base Formulation

| | |
|---|---|
| Polyamide Resin Blend | 351 g |
| Dispersing Agent | 5 g |
| 2-Butanol Solvent | 73 g |
| TiO₂ (R-960) | 146 g |
| Organic-Based Ionic Exchange Resin(s) | 14 g |
| Extender/Filler Pigment | 411 g |
| Mill Base Total: | 1000 g |

The concentration of the corrosion inhibitors used as individuals range from 0.5 wt % (CM23+Pr₆O₁₁ panel I216) to 1.0 wt % (DE 23, panel I10). Where the wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst would consist of a solvent, an additive, and a resin blend, such as Deft's epoxy/nitroethane solution, manufacturer's code number 44WO16CAT.

Examples of such primer formulations that have been prepared and evaluated are provided in Tables 1 and 2, below.

Organic-based, pre-exchanged ionic exchange resins have been evaluated as being non-toxic alternatives to chromates. Organic-based cationic and or anionic ionic exchange resins that have been pre-exchanged with rare earth cations and or amino acids; for example Whatman fibrous cellulose phosphate cation exchanger P11 pre-exchanged with a solution containing salts, oxides and mixed oxides, and or compounds or rare earths, Whatman fibrous cellulose phosphate cation exchanger P11 pre-exchanged with a solution containing amine-based aliphatic, aromatic, cyclic, and or sulfur and or iodide containing compounds and or derivatives of any of the above, etc. have been incorporated into polyamide/epoxy water reducible primer formulations. One example of a polyamide/epoxy water reducible primer mill base formulation containing these types of compounds is as follows:

### Example 8

Primer Mill Base Formulation

| | |
|---|---|
| Polyamide Resin Blend | 351 g |
| Dispersing Agent | 5 g |
| 2-Butanol Solvent | 73 g |
| Ti0₂ | 146 g |
| Pre-Exchanged Organic-Based | 14 g |
| Ionic Exchange Resin(s) | |
| Extender/Filler Pigment | 411 g |
| Mill Base Total: | 1000 g |

The concentration of the corrosion inhibitors used range from 0.5 wt % (P11+Pr(NO₃)₃, panel I162) to 2.5 wt % (P11+D,L-Methionine panel I5). Where the wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst/activator would consist of a solvent, an additive, and a resin blend, such as Deft's epoxy/nitroethane solution, manufacturer's code number 44WO16CAT.

Examples of such primer formulations that have been prepared and evaluated are provided in Tables 1 and 2 below.

Metal sulfates have been evaluated as being nontoxic alternatives to chromates. Metal sulfates, such as praseodymium sulfate or other rare earth sulfates, magnesium sulfate, calcium sulfate, strontium sulfate, and the like, have been incorporated into polyamide/epoxy water reducible primer formulations. One example of the composition, concentrations, material ratios, vendor materials, or vendor supplier, of a polyamide/epoxy water reducible primer mill base formulation containing these types of compounds is as follows:

### Example 9

Primer Mill Base Formulation

| | |
|---|---|
| Polyamide Resin Blend | 351 g |
| Dispersing Agent | 5 g |
| 2-Butanol Solvent | 73 g |
| TiO₂ | 146 g |
| Metal Sulfate(s) | 14 g |
| Extender/Filler Pigment | 411 g |
| Mill Base Total: | 1000 g |

The concentration of the corrosion inhibitors used as individuals range from 1.44 wt % (Pr₂(SO₄)₃ panel A220) to 18.5 wt % (SrSO₄, panel 267). Where the wt % of inhibitor is based on a fully catalyzed and water reduced primer where the spray viscosity is equal to about 22 seconds on a standard EZ Zhan 2 Cup.

The polyamide/epoxy water reducible primer mill base was then well mixed with appropriate amounts of the epoxy catalyst blend as described above and recommended by the supplier of the resin. One example of an epoxy catalyst would consist of a solvent, an additive, and a resin blend, such as Deft's epoxy, nitroethane solution, manufacturer's code number 44WO16CAT.

Examples of such primer formulations that have been prepared and evaluated are provided in Tables 1 and 2, below.

Combinations of all of the above have been evaluated as being non-toxic alternatives to chromates. Combinations of all of the above, such as L-arginine+praseodymium(III/IV)oxide+calcium sulfate dihydrate, praseodymium sulfate+calcium sulfate+arginine, praseodymium(III/IV) oxide+calcium sulfate+methionine, praseodymium(III)oxide+praseodymium pre-exchanged cationic exchange resin P11+praseodymium(III/IV)oxide, etc., have been incorporated into polyamide/epoxy water reducible primer formulations. One example of a polyamide/epoxy water reducible primer mill base formulation containing rare earth salts is as follows:

### Example 10

| | |
|---|---|
| Polyamide Resin Blend | 336 g |
| Dispersing Agent | 5 g |
| 2-Butanol Solvent | 71 g |
| TiO₂ | 140 g |
| Pre-Exchanged Organic-Base | 14 g |
| Ionic Exchange Resin | |
| Pr₆O₁₁ | 40 g |
| Extender/Filler Pigment | 394 g |
| Mill Base Total: | 1000 g |

The concentration of the corrosion inhibitors used as combinations range from 0.12 wt % (Ce(NO₃)₃+Free EDTA, panel D36) to 30.6 wt % (Ce(NO₃)₃+Na₂EDTA+Pr₆O₁₁+CaSO₄.2H₂O panel A38). Where the wt % of inhibitor is based on a fully catalyzed and water reduced primer, the spray viscosity is equal to about 22 seconds on a standard EZ Zhan 2 Cup.

This polyamide/epoxy water reducible primer mill base would then be well mixed with appropriate amounts of the epoxy catalyst blend as described above and recommended by the supplier of the resin. One example of an epoxy catalyst would consist of a solvent, an additive, and a resin blend, such as Deft's epoxy/nitroethane solution, manufacturer's code number 44WO16CAT.

Examples of such primer formulations that have been prepared and evaluated are provided in Tables 1 and 2, below.

The concentration of the corrosion inhibitors used as combinations range from 0.12 wt % (Ce(NO₃)₃+Free EDTA panel D36) to 30.6 wt % (Ce(NO₃)₃+Na₂EDTA+Pr₆O₁₁+CaSO₄.2H₂O panel A38). Where the wt % of inhibitor is based on a fully catalyzed and water reduced primer, the spray viscosity is equal to about 22 seconds on a standard EZ Zhan 2 Cup.

This polyamide/epoxy water reducible primer mill base was then well mixed with appropriate amounts of the epoxy catalyst blend as described above and as recommended by the supplier of the resin. One example of an epoxy catalyst would consist of a solvent, an additive, and a resin blend, such as Deft's epoxy, nitroethane solution, manufacturer's code number 44WO16CAT.

Examples of such primer formulations that have been prepared and evaluated on aluminum alloys are provided in Tables 1 and 2 below.

### Primer Panel Summary

TABLE 1
Corrosion Codes/Rankings Employed in Table 2

| Code | Scribe line ratings - Description |
|---|---|
| 1 | Scribe line beginning to darken or shiny scribe. |
| 2 | Scribe lines >50% darkened. |
| 3 | Scribe line dark. |
| 4 | Several localized sites of white salt in scribe lines. |
| 5 | Many localized sites of white salt in scribe lines. |
| 6 | White salt filling scribe lines. |
| 7 | Dark corrosion sites in scribe lines. |
| 8 | Few blisters under primer along scribe line. (<12) |
| 9 | Many blisters under primer along scribe line. |
| 10 | Slight lift along scribe lines. |
| 11 | Coating curling up along scribe. |
| 12 | Pin point sites/pits of corrosion on organic coating surface |
| | (1/16″ to ⅛″ dia.). |
| 13 | One or more blisters on surface away from scribe. |
| 14 | Many blisters under primer away from scribe. |
| 15 | Blisters over surface |

Corrosion creepage beyond scribe in inches

| | |
|---|---|
| A. | No creepage |
| B. | 0 to 1/64 |
| C. | 1/64 to 1/32 |
| D. | 1/32 to 1/16 |
| E. | 1/16 to ⅛ |
| F. | ⅛ to 3/16 |
| G. | 3/16 to ¼ |
| H. | ¼ to ⅜ |

TABLE 2
Panels Prepared And Evaluated

| | | Weight Percent* | | 2000 HRS |
|---|---|---|---|---|
| Panel | Corrosion | Inhibitor | Extender/ | Salt Fog |
| Number | Inhibitor | Conc. | Transport Enhancer | Rating |
| 10 | SrCrO₄ | — | — | 1 A |
| D1 | Ce(NO₃)₃ | 0.15 | Kaolin | 3,6 A |
| D12 | Ce(NO₃)₃ | 5.0 | Kaolin | 3,6 A |
| D3 | Ce(NO₃)₃ | 3.0 | CaSO₄(anhy.) | 3,6 A |
| D40 | Ce(NO₃)₃ | 0.4 | CaSO₄(anhy.) | 3,6 A |
| D13 | Ce(NO₃)₃ | 5.0 | CaSO₄(anhy.) | 3,6 A |
| D42 | Ce(NO₃)₃ | 0.4 | CaSO₄.2H₂O | 3,5 A |
| D140 | Ce(NO₃)₃ | .051 | CaSO₄.2H₂O | 3,5 A |
| D49 | Ce(NO₃)₃ | 5.0 | CaSO₄.2H₂O | 3,6 A |
| D73 | Ce(NO₃)₃ | .75/.50 | CaSO₄.2H₂O | 3,6 A |
| | H₃(CF₃SO₃)₃ | | | |
| D44 | Ce(NO₃)₃ | 0.5 | Deft (Mistron 600) | 3,6 A |
| D14 | Ce(NO₃)₃/BaB₂O₄ | 8.0/8.0 | Kaolin | 3,6 A |
| Gen I | CeO₂.2H₂O | 32 | Mistron 600 | 3,6 A |
| D11 | Ce(NO₃)₃/CePO₄ | 0.3/0.3 | Kaolin | 3,6 A |
| D15 | Ce(NO₃)₃/Pr(NO₃)₃/ | 1.0/1.0/ | Kaolin | 3,5 A |
| | BaB₂O₄ | 1.0 | | |
| D16 | Ce(NO₃)₃/Pr(NO₃)₃/ | 0.4 | CaSO₄.2H₂O | 3,5 A |
| | BaB₂O₄ | | | |
| D17 | Ce(NO₃)₃/Pr(NO₃)₃/ | 0.4/0.4/ | Nicron 604 | 3,6 A |
| | BaB₂O₄ | 0.4 | | |
| D18 | — | 0.0 | CaSO₄.2H₂O | 3,5 A |
| D19 | — | 0.0 | Nicron 604 | 3,6 A |
| C1 | Na₂EDTA | 0.9 | CaSO₄.2H₂O | 3,5 A |
| D50 | Ce(NO₃)₃ + Acid | 1.5 | CaSO₄.2H₂O | 3,4 A |
| D51 | Ce(NO₃)₃ + Base | 1.5 | CaSO₄.2H₂O | 3,4 A |
| D53 | Ce(NO₃)₃ + Base | 1.5 | CaSO₄.2H₂O | 3,4 A |
| D54 | Ce(NO₃)₃ + Acid + H₂0₂ | 1.5 | CaSO₄.2H₂O | 3,4 A |
| D55 | Ce(NO₃)₃ + Base + H₂0₂ | 1.5 | CaSO₄.2H₂O | 3,4 A |
| D56 | Ce(NO₃)₃ + Base + H₂0₂ | 1.5 | CaSO₄.2H₂O | 3,4 A |
| A1 | PrCl₃ | 3.0 | Kaolin | 3,6 A |
| A2 | Pr(NO₃)₃ | 3.0 | Kaolin | 3,6 A |
| A5 | Pr(NO₃)₃ | 1.0 | Kaolin | 3,6 A |
| A4 | Pr(NO₃)₃ | 8.0 | Kaolin | 3,6 A |
| A11 | Pr(NO₃)₃/BaB₂O₄ | 3.0/3.0 | Kaolin | 3,6 A |
| A3 | Pr(NO₃)₃ | 3.0 | CaSO₄(anhy.) | 3,5 A |
| A8 | Pr(NO₃)₃ | 1.0 | CaSO₄(anhy.) | 3,5 A |
| A9 | Pr(NO₃)₃ | 5.0 | CaSO₄(anhy.) | 3,5 A |
| A12 | Pr(NO₃)₃ | 0.5 | CaSO₄.2H₂O | 3,5 A |
| A26 | Pr(NO₃)₃/Pr₆O₁₁ | 1.5/1.5 | CaSO₄.2H₂O | 3,4 A |
| A33 | Pr(NO₃)₃/Pr₆O₁₁ | 2.0/3.1 | CaSO₄.2H₂O | 3,4 A |
| A46 | Pr(NO₃)₃/Ce(NO₃)₃ | 0.7/1.0 | CaSO₄.2H₂O | 3,4 A |
| A19 | PrCO₃ | 1.0 | CaSO₄.2H₂O | 3,5 A |
| A21 | PrCO₃ | 3.0 | Nicron 604 | 3,6 A |
| A63 | Pr(NO₃)₃ + Acid | 1.5 | CaSO₄.2H₂O | 3,5 A |
| A64 | Pr(NO₃)₃ + Base | 1.5 | CaSO₄.2H₂O | 3,4 A |
| A65 | Pr(NO₃)₃ + Base | 1.5 | CaSO₄.2H₂O | 3,4 A |
| A28 | Ce(NO₃)₃/Pr₆O₁₁/ | 3.1/1.0/ | CaSO₄.2H₂O | 3,4 A |
| | Gelatin | 1.0 | | |
| A66E | Ce(NO₃)₃/Pr₆O₁₁/ | 1.5/1.5/ | CaSO₄.2H₂O | 1,4 A |
| | Gelatin | 0.03 | | |
| A31 | Ce(NO₃)₃/Pr₆(NO₃)₃/ | 1.0/0.7/ | CaSO₄.2H₂O | 2,4 A |
| | Gelatin | 0.2 | | |
| D28 | Ce(NO₃)₃/Gelatin | 3.0/0.2 | CaSO₄.2H₂O | 2,4 A |
| A38 | Ce(NO₃)₃/Na₂EDTA/ | 1.0/16/ | CaSO₄.2H₂O | 2,4 A |
| | Pr₆O₁₁ | 3.1 | | |
| C13 | Ce(NO₃)₃/Na₂EDTA/ | 0.5/16/ | CaSO₄.2H₂O | 2,4 A |
| | Pr₆O₁₁ | 1.0 | | |
| C14 | Ce(NO₃)₃/Na₂EDTA/ | 0.5/16/ | CaSO₄.2H₂O | 2,4 A |
| | Pr₆O₁₁/AlPO₄ | 1.0/3.0 | | |
| A37 | Ce(NO₃)₃/Pr₆O₁₁ | 1.0/3.1 | CaSO₄.2H₂O | 2,4 A |
| A47 | Ce(NO₃)₃/Pr₆O₁₁ | 1.4/0.7 | CaSO₄.2H₂O | 2,4 A |
| C18 | Ce(NO₃)₃/Na₂EDTA/ | 0.5/16/ | CaSO₄(anhy.) | 3,4 A |
| | Pr₆O₁₁ | 1.0 | | |
| C19 | Ce(NO₃)₃/Na₂EDTA/ | 0.5/16/ | CaSO₄(anhy.) | 3,4 A |
| | Pr₆O₁₁/AlPO₄ | 1.0/3.0 | | |
| A48 | Ce(NO₃)₃/Pr₆O₁₁ | 1.4/0.7 | CaSO₄(anhy.) | 3,4 A |
| NH1 | Nd(NO₃)₃ | 3.0 | Kaolin | 3,6 A |
| NH2 | Sm(C₂H₃O₂)₃ | 3.0 | Kaolin | 3,6 A |
| K1 | K-White | 1.0 | CaSO₄.2H₂O | 3,6 A |
| | (Commercial) | | | |
| K2 | K-White | 3.0 | CaSO₄.2H₂O | 2,4 A |
| | (Commercial) | | | |
| C1 | Na₂EDTA | 0.9 | CaSO₄.2H₂O | 3,6 A |
| C2 | Na₂EDTA | 1.8 | CaSO₄.2H₂O | 3,6 A |
| D26 | Ce(NO₃)₃/Na₂EDTA | 0.25/0.25 | CaSO₄.2H₂O | 3,6 A |
| D1:.5 | Ce(NO₃)₃/Na₂EDTA | 4.7/4.7 | CaSO₄.2H₂O | 3,6 A |
| C3 | Free EDTA | Saturated | CaSO₄.2H₂O | 3,6 A |
| D36 | Ce(NO₃)₃/Free EDTA | 0.06/0.06 | CaSO₄.2H₂O | 3,6 A |
| D32 | Ce(NO₃)₃/Free EDTA | 1.4/0.6 | CaSO₄.2H₂O | 3,6 A |
| D38 | Ce(NO₃)₃/Na₂EDTA/ | 0.7/2.0/ | CaSO₄.2H₂O | 3,6 A |
| | Gelatin | 0.2 | | |
| C5 | Pr₆O₁₁/Na₂EDTA | 3.1/16 | CaSO₄.2H₂O | 2,4 A |
| C5 | Pr₆O₁₁/Na₂EDTA | 1.5/16 | CaSO₄.2H₂O | 2,4 A |
| A51 | Pr(CF₃SO₃)₃ | 1.5 | Deft Primer | 2,4 A |
| | | | (Mistron 600) | |
| A68 | Pr(CF₃SO₃)₃ | 2.2 | Deft Primer | 2,5 A |
| | | | (Mistron 600) | |
| A54 | Pr(CF₃SO₃)₃ | 1.5 | CaSO₄.2H₂O | 2,4 A |
| A59 | Pr(CF₃SO₃)₃ | 1.0 | CaSO₄.2H₂O | 2,4 A |
| A67 | Pr(CF₃SO₃)₃ | 2.2 | CaSO₄.2H₂O | 2,4 A |
| D71 | Pr(NO₃)₃/ | 1.5/2.2 | CaSO₄.2H₂O | 3,4 A |
| | Pr(CF₃SO₃)₃ | | | |
| NH10 | LiSO₄ | 2.5 | CaSO₄.2H₂O | 3,4 A |
| NH11 | LiSO₄ | 2.5 | Deft Primer | 3,6 A |
| | | | (Mistron 600) | |
| A10 | Pr₆O₁₁ | 3.0 | CaSO₄(anhy.) | 3,5 A |
| A40 | Pr₆O₁₁ | 5.0 | CaSO₄(anhy.) | 3,5 A |
| A22 | Pr₆O₁₁ | 1.0 | CaSO₄.2H₂O | 3,4 A |
| A23 | Pr₆O₁₁ | 5.0 | CaSO₄.2H₂O | 3,4 A |
| A41 | Pr₆O₁₁ | 3.0 | CaSO₄.2H₂O | 2,5 A |
| A25 | Pr₆O₁₁ | 3.0 | Nicron 604 | 3,6 A |
| A50 | Pr₆O₁₁ | 1.5 | Deft Primer | 3,6 A |
| | | | (Mistron 600) | |
| 8-X6 | Pr₆O₁₁ | 1.5 | Deft Primer | 3,6 A |
| | | | (Mistron 600) | |
| A70 | Pr₆O₁₁ | 5 | Deft Primer | 2,4 A |
| | | | (Mistron 600) | |
| 8-X7 | Pr₆O₁₁ | 1.5 | CaSO₄.2H₂O | 3,6 A |
| A-69 | Pr₆O₁₁ | 5 | CaSO₄.2H₂O | 1,4 A |
| C4 | D,L-Methionine | 0.51 | CaSO₄.2H₂O | 3,6 A |
| C31 | D,L-Methionine | 0.51 | CaSO₄.2H₂O | 2,4 A |
| C9 | D,L-Methionine | 0.51 | CaSO₄(anhy.) | 3,6 A |
| C11 | D,L-Methionine/ | 0.51/2 | CaSO₄.2H₂O | 3,6 A |
| | Ce(NO₃)₃ | | | |
| C16 | D,L-Methionine/ | 0.51/ | CaSO₄.2H₂O | 3,6 A |
| | Ce(NO₃)₃ | 1.5 | | |
| C17 | D,L-Methionine/ | 0.51/ | CaSO₄.2H₂O | 3,6 A |
| | Ce(NO₃)₃ | 3.0 | | |
| D60 | D,L-Methionine/ | 0.51/ | Deft Primer | 3,6 A |
| | Ce(NO₃)₃ | 3.0 | (Mistron 600) | |
| C10 | D,L-Methionine/ | 0.51/2 | CaSO₄(anhy.) | 3,6 A |
| | Ce(NO₃)₃ | | | |
| C21 | D,L-Methionine/ | 0.51/ | CaSO₄(anhy.) | 3,6 A |
| | Ce(NO₃)₃ | 1.5 | | |
| C22 | D,L-Methionine/ | 0.51/ | CaSO₄(anhy.) | 3,6 A |
| | Ce(NO₃)₃ | 3.0 | | |
| C6 | D,L-Methionine/ | 3.1/ | CaSO₄.2H₂O | 2,4 A |
| | Pr₆O₁₁ | 3.1 | | |
| C15 | D,L-Methionine/ | 0.51/ | CaSO₄.2H₂O | 2,5 A |
| | Pr₆O₁₁ | 1.0 | | |
| C8 | D,L-Methionine/ | 0.51/ | CaSO₄.2H₂O | 3,4 A |
| | Pr₆O₁₁ | 3.1 | | |
| C35 | D,L-Methionine/ | 0.51/ | CaSO₄ 2H₂O | 2,4 A |
| | Pr₆O₁₁/Ce(NO₃)₃ | 1.5/1.5 | | |
| C37 | L-Arginine/Ce(NO₃)₃ | 1.5/1.5 | CaSO₄.2H₂O | 2,5 A |
| D57 | L-Arginine/Ce(NO₃)₃ | 2.0/1.0 | CaSO₄.2H₂O | 2,5 A |
| D58 | L-Arginine/Ce(NO₃)₃ | 2.0/1.0 | Deft Primer | 3,6 A |
| | | | (Mistron 600) | |
| C40 | L-Arginine/Ce(NO₃)₃/ | 1.5/1.5/ | CaSO₄.2H₂O | 2,4 A |
| | Pr₆O₁₁ | 1.5 | | |
| C38 | Cyclodextrin/Ce(NO₃)₃ | 1.5/1.5 | CaSO₄.2H₂O | 2,5 A |
| C41 | Cyclodextrin/Ce(NO₃)₃/ | 1.5/1.5/ | CaSO₄.2H₂O | 2,5 A |
| | Pr₆O₁₁ | 1.5 | | |
| C39 | Cyclodextrin/Ce(NO₃)₃/ | 1.5/1.5/ | CaSO₄.2H₂O | 2,5 A |
| | EDTA | 1.5 | | |
| C42 | Cyclodextrin/Ce(NO₃)₃/ | 1.5/1.5 | CaSO₄.2H₂O | 2,5 A |
| | Pr₆O₁₁/EDTA | 1.5/1.5 | | |
| 0179 | D,L-Methionine Sulfoxide | 0.51 | CaSO₄.2H₂O | 1 A |
| 0160 | L-Methionine | 0.51 | CaSO₄.2H₂O | 1 A |
| | Methylsulfonium Iodide | | | |
| I162 | P11 + Pr(NO₃)₃ | 0.5 | CaSO₄.2H₂O | 2 A |
| I163 | CM23 + Pr(NO₃)₃ | 0.5 | CaSO₄.2H₂O | 2 A |
| C70 | Reilex | 1.0 | CaSO₄.2H₂O | 3,6 A |
| C72 | Pr₆O₁₁/Reilex | 1.5/1.0 | CaSO₄.2H₂O | 2,5 A |
| I2 | Methionine/Reilex | 1.5/1.0 | CaSO₄.2H₂O | 2,5 A |
| I3 | P11 | 1.0 | CaSO₄.2H₂O | 2,3 A |
| I4 | Pr₆O₁₁/P11 | 1.5/1.0 | CaSO₄.2H₂O | 1,4 A |
| I5 | Methionine/P11 | 1.5/1.0 | CaSO₄.2H₂O | 3,6 A |
| I6 | CM23 | 1.0 | CaSO₄.2H₂O | 2,4 A |
| I7 | PrFMS/CM23 | 1.5/1.0 | CaSO₄.2H₂O | 2,3 A |
| I8 | Pr₆O₁₁ CM23 | 1.5/1.0 | CaSO₄.2H₂O | 1 A |
| I9 | Methionine/CM23 | 1.5/1.0 | CaSO₄.2H₂O | 2,3 A |
| I10 | DE23 | 1.0 | CaSO₄.2H₂O | 2 A |

Generation Vb

| | | | | |
|---|---|---|---|---|
| A136 | Pr₂O₃ | 1.5 | 10.5% CaSO₄.2H₂O | 1 A |
| A137 | Pr₆O₁₁-m | 1.5 | 10.5% CaSO₄.2H₂O | 1 A |
| A138 | PrO₂ | 1.5 | 10.5% CaSO₄.2H₂O | 1 A |
| A139 | Pr₆O₁₁ | 1.5 | 10.5% CaSO₄.2H₂O | 1 A |
| D140 | Ce(NO₃)₃ | .051 | 10.5% CaSO₄.H₂O | 3,5 A |
| A141 | Pr₂O₃ | 1.5 | 12.4% CaSO₄.2H₂O | 1 A |
| A142 | Pr₆O₁₁-m | 1.5 | 12.4% CaSO₄.2H₂O | 1 A |
| A143 | PrO₂ | 1.5 | 12.4% CaSO₄.2H₂O | 1 A |
| A144 | Pr₆O₁₁ | 1.5 | 12.4% CaSO₄.2H₂O | 1 A |
| D145 | Ce(NO₃)₃ | .051 | 12.4% CaSO₄.2H₂O | 3,5 A |
| A146 | Pr₂O₃ | 1.5 | 15.6% CaSO₄.2H₂O | 1 A |
| A147 | Pr₆O₁₁-m | 1.5 | 15.6% CaSO₄.2H₂O | 1 A |
| A148 | PrO₂ | 1.5 | 15.6% CaSO₄.2H₂O | 1 A |
| A149 | Pr₆O₁₁ | 1.5 | 15.6% CaSO₄.2H₂O | 1 A |
| A150 | Pr₂O₃ | 1.5 | 10.1% CaSO₄.2H₂O | 1 A |
| A151 | Pr₂O₃ | 0.4 | 10.1% CaSO₄.2H₂O | 1 A |
| A152 | Pr₂O₃ | 0.4 | 14.6% CaSO₄.2H₂O | 1 A |
| A153 | Pr₂O₃ | 3.7 | 13.4% CaSO₄.2H₂O | 1 A |

Generation Vd

| | | | | |
|---|---|---|---|---|
| A220 | PrSO₄ | 1.44 | 15.0% CaSO₄.2H₂O | 1 A |
| T221 | Tb₃O₇ | 1.44 | 15.0% CaSO₄.2H₂O | 1 A |
| 223 | Pr(OH)₃ | 1.44 | 15.0% CaSO₄.2H₂O | 1,4 A |
| 224 | Pr₆O₁₁ | 1.95 | 14.8% CaSO₄.2H₂O | 1 A |
| 225 | Pr₆O₁₁ | 5.61 | 14.2% CaSO₄.2H₂O | 1 A |
| 226 | Pr₂O₃ | 1.5 | 15.0% CaSO₄.2H₂O | 1 A |
| 227 | Pr₆O₁₁ | 22.4 | 0.0% CaSO₄.2H₂O | 2,5 A |
| 228 | Pr₂O₃/Pr₆O₁₁/ | 1.4/1.4 | 14.0% CaSO₄.2H₂O | 1 A |
| | PrSO₄/D,L | .77/.25 | | |
| | Methionine | | | |
| 229 | PrO₂/Glycine | 0.4/1.08 | 15.0% CaSO₄.2H₂O | 1 A |
| 230 | D-Methionine | 1.05 | 15.2% CaSO₄.2H₂O | 1 A |
| 231 | D,L-Methionine | 0.53 | 15.4% CaSO₄.2H₂O | 1 A |
| 232 | D,L-Methionine | 1.54 | 15.0% CaSO₄.2H₂O | 1 A |
| 233 | L-Cystiene | 1.05 | 15.2% CaSO₄.2H₂O | 1 A |
| 234 | D,L-Methionine | 1.05 | 15.2% CaSO₄.2H₂O | 1 A |
| | Sulfoxide | | | |
| 235 | L-Arginine | 1.05 | 15.2% CaSO₄.2H₂O | 1 A |
| 237 | Pr₆O₁₁ | 1.47 | 15.0% CaSO₄.2H₂O | 1 A |
| 238 | Pr₂O₃ | 1.47 | 15.0% CaSO₄.2H₂O | 1 A |
| 239 | Pr₆O₁₁ | 1.47 | 19.5% BaSO₄ | 3,5 A |
| 240 | Pr₂O₃ | 1.47 | 19.5% BaSO₄ | 3,5 A |
| 241 | Pr₆O₁₁ | 1.47 | 17.3% SrSO₄ | 1 A |
| 242 | Pr₂O₃ | 1.47 | 17.3% SrSO₄ | 1 A |
| 243 | Pr₆O₁₁ | 1.47 | 15.0% MgSO₄ | Not Tested |
| 244 | Pr₂O₃ | 1.47 | 15.0% MgSO₄ | Not Tested |

Generation IV

| | | | | |
|---|---|---|---|---|
| D80 | — | 0.0 | Deft (Mistron 600) | 3,5 A |
| A81 | Pr(CF₃SO₃)₃ | 1.5 | Deft (Mistron 600) | 3,4 A |
| A82 | Pr₆O₁₁ | 1.5 | Deft (Mistron 600) | 3,4 A |
| A83 | Pr(CF₃SO₃)₃ | 0.7 | Deft (Mistron 600) | 3,4 A |
| D84 | — | 0.0 | 10.6% CaSO₄.2H₂O | 1,4 A |
| A85 | Pr(CF₃SO₃)₃ | 1.5 | 10.6% CaSO₄.2H₂O | 2 A |
| A86 | Pr₆O₁₁ | 1.5 | 10.6% CaSO₄.2H₂O | 1,4 A |
| A87 | Pr₆O₁₁ | 3.0 | 10.6% CaSO₄.2H₂O | 1 A |
| C88 | Pr₆O₁₁/ | 1.5/ | 10.6% CaSO₄.2H₂O | 1 A |
| | D,L-Methionine/ | 0.51/ | | |
| | L-Arginine | 0.51 | | |
| C89 | D,L-Methionine/ | 0.51/ | 10.6% CaSO₄.2H₂O | 1 A |
| | L-Arginine | 0.51 | | |
| D90 | Ce(NO₃)₃ | 0.51 | 10.6% CaSO₄.2H₂O | 1 A |
| C91 | Ce(NO₃)₃/ | 0.51/ | 10.6% CaSO₄.2H₂O | 2 A |
| | L-Arginine | 0.51 | | |
| A92 | Ce(NO₃)₃/Pr₆O₁₁ | 0.51/1 | 10.6% CaSO₄.2H₂O | 2,4 A |
| A93 | Pr(CF₃SO₃)₃ | 3.0 | 12.3% CaSO₄.2H₂O | 2 A |
| A94 | Pr₆O₁₁ | 1.5 | 12.3% CaSO₄.2H₂O | 1 A |
| A95 | Pr₆O₁₁ | 3.0 | 12.3% CaSO₄.2H₂O | 1,4 A |
| C96 | D,L-Methionine/ | 0.51/ | 12.3% CaSO₄.2H₂O | 1 A |
| | L-Arginine | 0.51 | | |
| C97 | Ce(NO₃)₃/ | .051/ | 12.3% CaSO₄.2H₂O | 2 A |
| | L-Arginine | 0.51 | | |
| A98 | Pr₆O₁₁ | 3.0 | 12.3% CaSO₄.2H₂O | 1 A |

Generation Vc

| | | | | |
|---|---|---|---|---|
| 199 | — | 0.0 | 15.6% CaSO₄.2H₂O | 2 A |
| A200 | Pr₂O₃ | 1.44 | 15.0% CaSO₄.2H₂O | 1 A |
| A201 | Pr₂O₃ | 2.77 | 14.5% CaSO₄.2H₂O | 1 A |
| A202 | Pr₂O₃ | 3.71 | 14.1% CaSO₄.2H₂O | 1 A |
| A201 | Pr₂O₃ hand mixed | 1.47 | 15.0% CaSO₄.2H₂O | 1 A |
| A204 | PrO₂ | 1.44 | 15.0% CaSO₄.2H₂O | 1 A |
| A205 | PrO₂ | 2.18 | 14.7% CaSO₄.2H₂O | 2 A |
| A206 | PrO₂ - hand mixed | 1.47 | 15.0% CaSO₄.2H₂O | 1 A |
| A207 | PrO₂ + Pr₂O₃ | 1.44 | 15.0% CaSO₄.2H₂O | 1 A |
| A208 | PrO₂ + Pr₂O₃ | 2.18 | 14.7% CaSO₄.2H₂O | 1 A |
| A209 | PrO₂ + Pr₂O₃ hand | 1.47 | 15.0% CaSO₄.2H₂O | 1 A |
| | mixed | | | |
| A210 | Pr₆O₁₁ | 1.44 | 15.0% CaSO₄.2H₂O | 1 A |
| A211 | Pr₆O₁₁ | 2.77 | 14.5% CaSO₄.2H₂O | 1 A |
| A212 | Pr₆O₁₁ | 3.71 | 14.1% CaSO₄.2H₂O | 1 A |
| A213 | Pr₆O₁₁ - hand mixed | 1.47 | 15.0% CaSO₄.2H₂O | 1 A |
| O214 | D,L-Methionine | 0.50 | 15.4% CaSO₄.2H₂O | 1 A |
| O215 | D,L-Methionine/ | 0.51/ | 14.8% CaSO₄.2H₂O | 1 A |
| | Pr₆O₁₁ | 1.42 | | |
| I216 | CM23/Pr₆O₁₁ | 0.5/2.6 | 14.3% CaSO₄.2H₂O | 2 A |
| A219 | Pr₆O₁₁ | 1.44 | 15.0% CaSO₄.2H₂O | 1 A |

*Weight percent based on fully catalyzed and water reduced sprayable paint, such that 1000 g of mill base material is mixed with 400 g of Deft epoxy resin/catalysts/activator and 1273 g of water added in three portions with stirring.

### REFERENCES

1. H. E. Hager, Chromate-Free Protective Coatings, U.S. Pat. No. 5,866,652.

2. B. R. W. Hinton, Corrosion Prevention and Chromates, the End of an Era?, Metal Finishing, 89 [9] 55-61 (1991.

3. D. R. Arnott, Cationic-Film-Forming Inhibitors for the Protection of the AA 7075 Aluminum Alloy Against Corrosion in Aqueous Chloride Solution.

4. R. A. Cayless, Method of Producing Corrosion Inhibitors, U.S. Pat. No. 4,459,155.

5. D. A. Pippard, Corrosion Inhibitors, Method of Producing Them and Protective Coatings Containing Them, U.S. Pat. No. 4,405,493.

6. T. E. Fletcher, Corrosion-Inhibiting Composition, U.S. Pat. No. 5,041,241.

7. R. J. Howes, Process for Producing Corrosion Inhibiting Particles, U.S. Pat. No. 4,687,595.

8. M. S. Abdel-Aal, Inhibiting And Accelerating Effects of Some Amino Acids on the Corrosion Rate of Mild Steel in 3M H2SO4 Solution., Proceedings of the 8^{th} European Symposium on Corrosion Inhibitors, Sec. V, Suppl. N. 10, (1995).

9. V. Hluchan, Amino Acids as Corrosion Inhibitors in Hydrochloric Acid Solutions., Werkstoffe and Korrosion 39, 512-717 (1998).

10. M. A. Abdel-Rahim, Naturally Occurring Organic Substances as Corrosion Inhibitors for Mild Steel in Acid Medium., Mat.-wiss. U. Werkstofftech 28, 98-102(1997).

11. Z. Lukacs, A Study on the Corrosion Inhibition Effect of Arginine, Hystidine, and Methionine., Proceedings of the 8^{th} European Symposium on Corrosion Inhibitors, Sec. V, Suppl. N. 10, (1995).

We claim:

1. A corrosion inhibiting primer composition comprising:
a rare earth compound,
wherein said rare earth compound is an oxide or a mixed oxide of a rare earth metal,
and an organic polymer.

2. The composition of claim 1 wherein said rare earth compound is selected from the group consisting of praseodymium, terbium, cerium, samarium, ytterbium, yttrium, and neodymium.

3. The composition of claim 2 wherein said rare earth compound is a praseodymium compound.

4. The composition of claim 3 wherein said praseodymium compound is selected from the group consisting of praseodymium(III), praseodymium(III/IV), praseodymium(IV) compounds and mixtures thereof.

5. The composition of claim 4 wherein said praseodymium compound is a praseodymium(III) compound.

6. The composition of claim 4 wherein said praseodymium compound is a praseodymium(III/IV) compound.

7. The composition of claim 4 wherein said praseodymium compound is a praseodymium(IV) compound.

8. The composition of claim 1 which is selected from the group consisting of aqueous, solvent-based, and powder coating compositions.

9. The composition of claim 8 wherein said composition is an aqueous composition.

10. The composition of claim 1 wherein said organic polymer is selected from the group consisting of epoxy, urethane, urea, acrylate, alkyd, melamine, polyester, vinyl, vinyl ester, silicone, siloxane, silicate, sulfide, sulfone, epoxy novolac, epoxy phenolic, amides, drying oils, and hydrocarbon polymers.

11. The composition of claim 9 wherein said polymer is an epoxy polymer.

12. A corrosion inhibiting primer composition comprising:
a rare earth compound,
wherein said rare earth compound is an oxide or a mixed oxide of a rare earth metal,
and an organic polymer,
in combination with a material selected from the group consisting of
linear and cyclic dextrins, triflic acid, triflates, acetates, talc, kaolin, and organic-based ion exchange resins.

13. The composition of claim 12 wherein said rare earth compound is selected from the group consisting of praseodymium, terbium, cerium, samarium, ytterbium, yttrium, and neodymium.

14. The composition of claim 12 wherein said rare earth compound is a praseodymium compound.

15. The composition of claim 12 wherein said praseodymium compound is selected from the group consisting of praseodymium(III), praseodymium(III/IV), and praseodymium(IV) compounds.

16. The composition of claim 15 wherein said praseodymium compound is a praseodymium(III) compound.

17. The composition of claim 15 wherein said praseodymium compound is a praseodymium(III/IV) compound.

18. The composition of claim 15 wherein said praseodymium compound is a praseodymium(IV) compound.

19. The composition of claim 12 wherein said ion exchange resin is a cation exchange resin.

20. The composition of claim 12 which is selected from the group consisting of aqueous, solvent-based, and powder coating compositions.

21. The composition of claim 12 wherein said organic polymer is selected from the group consisting of epoxy, urethane, urea, acrylate, alkyd, melamine, polyester, vinyl, vinyl ester, silicone, siloxane, silicate, sulfide, sulfone, epoxy novolac, epoxy phenolic, amides, drying oils, and hydrocarbon polymers.

22. The composition of claim 21 wherein said polymer is an epoxy polymer.

23. A corrosion inhibiting primer composition comprising:
a rare earth compound,
wherein said rare earth compound is an oxide or a mixed oxide of a rare earth metal,
and an organic polymer,
in combination with a material selected from the group consisting of gelatin and gelatin derivatives.

24. The composition of claim 23 wherein said rare earth metal is selected from the group consisting of praseodymium, terbium, cerium, samarium, ytterbium, yttrium, and neodymium.

25. The composition of claim 24 wherein said rare earth compound is a praseodymium compound.

26. The composition of claim 25 wherein said praseodymium compound is selected from the group consisting of praseodymium(III), praseodymium(III/IV), and praseodymium(IV) compounds.

27. The composition of claim 26 wherein said praseodymium compound is a praseodymium(III) compound.

28. The composition of claim 26 wherein said praseodymium compound is a praseodymium(III/IV) compound.

29. The composition of claim 26 wherein said praseodymium compound is a praseodymium(IV) compound.

30. The composition of claim 23 wherein said gelatin is derived from the group consisting of pig gelatin or fish gelatin.

31. The coating composition of claim 23 which is selected from the group consisting of aqueous, solvent-based, and powder coating compositions.

32. The composition of claim 23 wherein said organic polymer is selected from the group consisting of epoxy, urethane, urea, acrylate, alkyd, melamine, polyester, vinyl, vinyl ester, silicone, siloxane, silicate, sulfide, sulfone, epoxy novolac, epoxy phenolic, amides, drying oils, and hydrocarbon polymers.

33. The composition of claim 32 wherein said polymer is an epoxy polymer.

34. A corrosion inhibiting primer composition comprising:
a rare earth compound,
wherein said rare earth compound is an oxide or a mixed oxide of a rare earth metal,
and an organic polymer,
in combination with a material selected from the group consisting of
amino acids and derivatives of amino acids.

35. The composition of claim 34 wherein said rare earth metal is selected from the group consisting of praseodymium, terbium, cerium, samarium, ytterbium, yttrium, and neodymium.

36. The composition of claim 34 wherein said rare earth compound is a praseodymium compound.

37. The composition of claim 36 wherein said praseodymium compound is selected from the group consisting of praseodymium(III), praseodymium(III/IV), and praseodymium(IV) compounds.

38. The composition of claim 37 wherein said praseodymium compound is a praseodymium(III) compound.

39. The composition of claim 37 wherein said praseodymium compound is a praseodymium(III/IV) compound.

40. The composition of claim 37 wherein said praseodymium compound is a praseodymium(IV) compound.

41. The composition of claim 34 wherein said amino acid is selected from the group consisting of glycine, arginine, and methionine.

42. The composition of claim 34 wherein said amino acid derivative is methionine sulfoxide or methionine methyl sulfoxide.

43. The coating composition of claim 34 which is selected from the group consisting of aqueous, solvent-based, and powder coating compositions.

44. The composition of claim 34 wherein said organic polymer is selected from the group consisting of epoxy, urethane, urea, acrylate, alkyd, melamine, polyester, vinyl, vinyl ester, silicone, siloxane, silicate, sulfide, sulfone, epoxy novolac, epoxy phenolic, amides, drying oils, and hydrocarbon polymers.

45. The composition of claim 44 wherein said polymer is an epoxy polymer.

46. A corrosion inhibiting primer composition comprising:
a rare earth compound,
wherein said rare earth compound is an oxide or a mixed oxide of a rare earth metal,
and an organic polymer,
in combination with a material selected from the group consisting of metal sulfates, wherein the metal sulfates are selected from the group consisting of anhydrous and hydrous magnesium sulfate, anhydrous and hydrous calcium sulfate, barium sulfate, samarium sulfate, and strontium sulfate.

47. The composition of claim 46 wherein said rare earth metal is selected from the group consisting of praseodymium, terbium, cerium, samarium, ytterbium, yttrium, and neodymium.

48. The composition of claim 46 wherein said rare earth compound is a praseodymium compound.

49. The composition of claim 46 wherein said praseodymium compound is selected from the group consisting of praseodymium(III), praseodymium(III/IV), and praseodymium(IV) compounds.

50. The composition of claim 49 wherein said praseodymium compound is a praseodymium(III) compound.

51. The composition of claim 49 wherein said praseodymium compound is a praseodymium(III/IV) compound.

52. The composition of claim 49 wherein said praseodymium compound is a praseodymium(IV) compound.

53. The composition of claim 46 wherein said metal sulfate is hydrous calcium sulfate.

54. The composition of claim 46 wherein said metal sulfate is strontium sulfate.

55. The coating composition of claim 46 which is selected from the group consisting of aqueous, solvent-based, and powder coating compositions.

56. The coating composition of claim 46 wherein said organic polymer is selected from the group consisting of epoxy, urethane, urea, acrylate, alkyd, melamine, polyester, vinyl, vinyl ester, silicone, siloxane, silicate, sulfide, sulfone, epoxy novolac, epoxy phenolic, amides, drying oils, and hydrocarbon polymers.

57. The composition of claim 56 wherein said polymer is an epoxy polymer.

58. The coating composition of claim 1 which additionally comprises a pigment.

59. The composition of claim 58 wherein said pigment is TiO₂.

60. The coating composition of claim 12 which additionally comprises a pigment.

61. The composition of claim 60 wherein said pigment is TiO₂.

62. The coating composition of claim 23 which additionally comprises a pigment.

63. The composition of claim 62 wherein said pigment is TiO₂.

64. The coating composition of claim 34 which additionally comprises a pigment.

65. The composition of claim 64 wherein said pigment is TiO₂.

66. The coating composition of claim 46 which additionally comprises a pigment.

67. The composition of claim 66 wherein said pigment is TiO₂.

68. A corrosion inhibiting primer composition comprising:
a rare earth carbonate,
and an organic polymer.

69. The composition of claim 68 wherein said rare earth carbonate is selected from the group consisting of praseodymium, terbium, cerium, samarium, ytterbium, yttrium, and neodymium.

70. The composition of claim 69 wherein said rare earth compound is a praseodymium compound.

71. The composition of claim 70 wherein said praseodymium compound is selected from the group consisting of praseodymium(III), praseodymium(III/IV), praseodymium(IV) compounds and mixtures thereof.

72. The composition of claim 71 wherein said praseodymium compound is a praseodymium(III) compound.

73. The composition of claim 71 wherein said praseodymium compound is a praseodymium(III/IV) compound.

74. The composition of claim 71 wherein said praseodymium compound is a praseodymium(IV) compound.

75. The composition of claim 68 which is selected from the group consisting of aqueous, solvent-based, and powder coating compositions.

76. The composition of claim 68 wherein said organic polymer is selected from the group consisting of epoxy, urethane, urea, acrylate, alkyd, melamine, polyester, vinyl, vinyl ester, silicone, siloxane, silicate, sulfide, sulfone, epoxy novolac, epoxy phenolic, amides, drying oils, and hydrocarbon polymers.

77. The composition of claim 76 wherein said polymer is an epoxy polymer.

78. A corrosion inhibiting primer composition comprising:
a rare earth triflate,
and an organic polymer.

79. The composition of claim 78 wherein said rare earth compound is selected from the group consisting of praseodymium, terbium, cerium, samarium, ytterbium, yttrium, and neodymium.

80. The composition of claim 78 wherein said rare earth compound is a praseodymium compound.

81. The composition of claim 80 wherein said praseodymium compound is selected from the group consisting of praseodymium(III), praseodymium(III/IV), praseodymium(IV) compounds and mixtures thereof.

82. The composition of claim 81 wherein said praseodymium compound is a praseodymium(III) compound.

83. The composition of claim 81 wherein said praseodymium compound is a praseodymium(III/IV) compound.

84. The composition of claim 81 wherein said praseodymium compound is a praseodymium(IV) compound.

85. The composition of claim 78 which is selected from the group consisting of aqueous, solvent-based, and powder coating compositions.

86. The composition of claim 78 wherein said organic polymer is selected from the group consisting of epoxy, urethane, urea, acrylate, alkyd, melamine, polyester, vinyl, vinyl ester, silicone, siloxane, silicate, sulfide, sulfone, epoxy novolac, epoxy phenolic, amides, drying oils, and hydrocarbon polymers.

87. The composition of claim 86 wherein said polymer is an epoxy polymer.

88. A method for coating a substrate with a composition comprising treating the substrate with a composition of claim 1, and curing the applied composition.

89. A method for coating a substrate which comprises treating the substrate with a conversion coating, applying the composition of claim 1, and curing the applied composition.

90. The method of claim 89 wherein said conversion coating is selected from the group consisting of cerium conversion coatings, praseodymium conversion coatings, phosphate conversion coatings, zinc-type conversion coatings, and chromium conversion coatings.

91. The method of claim 90 wherein said conversion coating is a chromium conversion coating.

92. A substrate coated with the composition of claim 1.

93. The substrate of claim 92 wherein said substrate is selected from the group consisting of aluminum, aluminum alloys, bare steel, galvanized steel, zinc, zinc alloys, magnesium, and magnesium alloys.

94. The substrate of claim 93 wherein said substrate is aluminum.

95. A method for coating a substrate with a composition comprising treating the substrate with a composition of claim 12, and curing the applied composition.

96. A method for coating a substrate which comprises treating the substrate with a conversion coating, applying the composition of claim 12, and curing the applied composition.

97. The method of claim 96 wherein said conversion coating is selected from the group consisting of cerium conversion coatings, praseodymium conversion coatings, phosphate conversion coatings, zinc-type conversion coatings, and chromium conversion coatings.

98. The method of claim 97 wherein said conversion coating is a chromium conversion coating.

99. A substrate coated with the composition of claim 12.

100. The substrate of claim 99 wherein said substrate is selected from the group consisting of aluminum, aluminum alloys, bare steel, galvanized steel, zinc, zinc alloys, magnesium, and magnesium alloys.

101. The substrate of claim 100 wherein said substrate is aluminum.

102. A method for coating a substrate with a composition comprising treating the substrate with a composition of claim 23, and curing the applied composition.

103. A method for coating a substrate which comprises treating the substrate with a conversion coating, applying the composition of claim 23, and curing the applied composition.

104. The method of claim 103 wherein said conversion coating is selected from the group consisting of cerium conversion coatings, praseodymium conversion coatings, phosphate conversion coatings, zinc-type conversion coatings, and chromium conversion coatings.

105. The method of claim 104 wherein said conversion coating is a chromium conversion coating.

106. A substrate coated with the composition of claim 23.

107. The substrate of claim 106 wherein said substrate is selected from the group consisting of aluminum, aluminum alloys, bare steel, galvanized steel, zinc, zinc alloys, magnesium, and magnesium alloys.

108. The substrate of claim 107 wherein said substrate is aluminum.

109. A method for coating a substrate with a composition comprising treating the substrate with a composition of claim 23, and curing the applied composition.

110. A method for coating a substrate which comprises treating the substrate with a conversion coating, applying the composition of claim 33, and curing the applied composition.

111. The method of claim 110 wherein said conversion coating is selected from the group consisting of cerium conversion coatings, praseodymium conversion coatings, phosphate conversion coatings, zinc-type conversion coatings, and chromium conversion coatings.

112. The method of claim 111 wherein said conversion coating is a chromium conversion coating.

113. A substrate coated with the composition of claim 34.

114. The substrate of claim 113 wherein said substrate is selected from the group consisting of aluminum, aluminum alloys, bare steel, galvanized steel, zinc, zinc alloys, magnesium, and magnesium alloys.

115. The substrate of claim 114 wherein said substrate is aluminum.

116. A method for coating a substrate with a composition comprising treating the substrate with a composition of claim 46, and curing the applied composition.

117. A method for coating a substrate which comprises treating the substrate with a conversion coating, applying the composition of claim 46, and curing the applied composition.

118. The method of claim 117 wherein said conversion coating is selected from the group consisting of cerium conversion coatings, praseodymium conversion coatings, phosphate conversion coatings, zinc-type conversion coatings, and chromium conversion coatings.

119. The method of claim 118 wherein said conversion coating is a chromium conversion coating.

120. A substrate coated with the composition of claim 46.

121. The substrate of claim 120 wherein said substrate is selected from the group consisting of aluminum, aluminum alloys, bare steel, galvanized steel, zinc, zinc alloys, magnesium, and magnesium alloys.

122. The substrate of claim 121 wherein said substrate is aluminum.

123. A method for coating a substrate with a composition comprising treating the substrate with a composition of claim 68, and curing the applied composition.

124. A method for coating a substrate which comprises treating the substrate with a conversion coating, applying the composition of claim 68, and curing the applied composition.

125. The method of claim 124 wherein said conversion coating is selected from the group consisting of cerium conversion coatings, praseodymium conversion coatings, phosphate conversion coatings, zinc-type conversion coatings, and chromium conversion coatings.

126. The method of claim 125 wherein said conversion coating is a chromium conversion coating.

127. A substrate coated with the composition of claim 68.

128. The substrate of claim 127 wherein said substrate is selected from the group consisting of aluminum, aluminum alloys, bare steel, galvanized steel, zinc, zinc alloys, magnesium, and magnesium alloys.

129. The substrate of claim 128 wherein said substrate is aluminum.

130. A method for coating a substrate with a composition comprising treating the substrate with a composition of claim 78, and curing the applied composition.

131. A method for coating a substrate which comprises treating the substrate with a conversion coating, applying the composition of claim 78, and curing the applied composition.

132. The method of claim 131 wherein said conversion coating is selected from the group consisting of cerium conversion coatings, praseodymium conversion coatings, phosphate conversion coatings, zinc-type conversion coatings, and chromium conversion coatings.

133. The method of claim 132 wherein said conversion coating is a chromium conversion coating.

134. A substrate coated with the composition of claim 78.

135. The substrate of claim 134 wherein said substrate is selected from the group consisting of aluminum, aluminum alloys, bare steel, galvanized steel, magnesium, and magnesium alloys.

136. The substrate of claim 135 wherein said substrate is aluminum.

137. The coating composition of claim 1 which comprises 0.1-40 wt % Pr₆O₁₁.

138. The coating composition of claim 1 which comprises 0.1-11.0 wt % Pr₆O₁₁.

139. The coating composition of claim 12 which comprises 0.03-5.0 wt % cyclodextrin, 0.1-0.5 wt % triflic acid, or 0.1-5.0 wt % ionic exchange resin.

140. The coating composition of claim 23 which comprises 0.03-5.0 wt % gelatin.

141. The coating composition of claim 34 which comprises 0.1-5.0 wt % amino acid.

142. The coating composition of claim 46 which comprises 6.0-35 wt % metal sulfate.

143. The coating composition of claim 46 which comprises 16.1-18.8 wt % metal sulfate.

144. The coating composition of claim 68 which comprises 0.5-5.0 wt % rare earth carbonate.

145. The coating composition of claim 78 which comprises 0.4-5 wt % rare earth triflate.

146. The coating composition of claim 68 which additionally comprises a pigment.

147. The coating composition of claim 78 which additionally comprises a pigment.

148. A corrosion inhibiting primer composition comprising:
a metal sulfate compound and an organic polymer,
wherein said metal is selected from the group consisting of calcium, strontium, and barium.
